(19) United States
(12) Patent Application Publication
(10) Pub. No.: US 2007/0119769 A1
(43) Pub. Date: May 31, 2007

(54) WATER FILTRATION DEVICE

(76) Inventor: Chin-Sheng Chen, Chang Hua Hsien (TW)

Correspondence Address: LEONG C LEI, PMB # 1008, 1867 YGNACIO VALLEY ROAD, WALNUT CREEK, CA, 94598, US

(21) Appl. No.: 11/286,345

(22) Filed: Nov. 25, 2005

(51) Int. Cl. B01D 24/36

(52) U.S. Cl. 210/280

(57) ABSTRACT

A water filtration device is provided herein. The major characteristic of the present invention lies in the use of a fan at the bottom of the water filtration device which mainly contains a number of tubular members sleeved together to form passageways to guide the water to drive the fan's rotation. As the blades of the fan spin, the water is propelled upward to sustain the filtering particles to continue moving amidst the water, in contrast to the prior approach which has the water to flow downward in one direction to confine the filtering particles.

### BACKGROUND OF THE INVENTION

(a) Technical Field of the Invention

The present invention generally relates to water filtration devices, and more particularly to a water filtration device that utilize a fan to keep filtering particles suspended in the water.

(b) Description of the Prior Art

FIG. 1 is a schematic sectional view showing the interior of a conventional household water filtration device. As illustrated, the water filtration device houses a large number of filtering particles usually made of Calcium Sulfite (CaSO₃) or materials having similar functions. As the water flow through the water filtration device, the filtering particles are stirred and react with the water molecules to remove the chlorine contained in the water.

As further illustrated in FIGS. 2A and 2B, the water flows through the water filtration device in one direction and, at the outlet of the device, a filtering screen is configured to prevent the filtering particles from being washed out of the device. As such, the filtering particles are inevitably accumulated and confined at the outlet under the influence of the single-direction water flow. The filtering particles therefore couldn't move freely around to react with the water molecules. Furthermore, the would cause the deposition of furring or debris on top of the filtering particles and therefore slow down the water flow. In addition, as the filtering particles are fixed at their positions, the water could only find its way through the tiny channels among the filtering particles and only those particles neighboring to the channels would contribute to the chlorine removal. The design of using filtering particles so that they could be stirred by the water flow turns out to be a complete failure. The accumulation of the filtering particle also causes the water filtration device to suffer larger water pressure, thereby reducing the operational life span of the device.

### SUMMARY OF THE INVENTION

The primary purpose of the present invention is to provide a water filtration device having a novel structure to obviate the foregoing shortcomings of the conventional approach.

The major characteristic of the present invention lies in the use of a fan at the bottom of the water filtration device. The present invention mainly contains a number of tubular members sleeved together to form passageways to guide the water to drive the fan's rotation. As the blades of the fan spin, the water is propelled upward to sustain the filtering particles to continue moving amidst the water, in contrast to the traditional approach which has the water to flow downward in one direction to confine the filtering particles.

As a result, the function of the filtering particles is fully exploited to remove the chlorine and debris from the water for a superior water filtration effect. And, as the water filtration device is operated under a smaller water pressure, the water filtration device therefore has a longer operational life.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical 6r similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic sectional view showing the interior of a conventional household water filtration device.

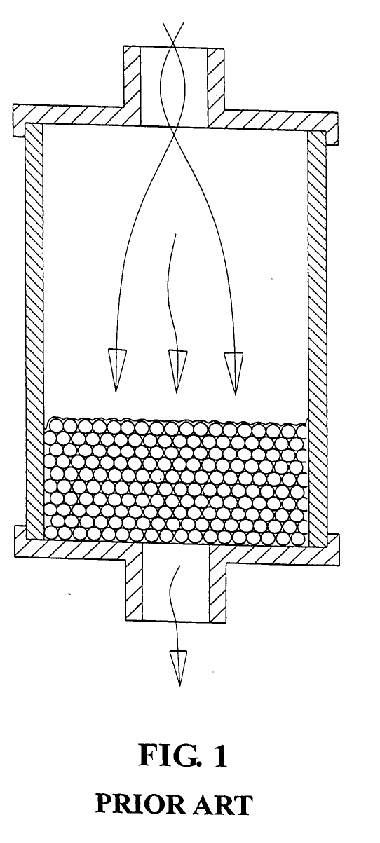

FIGS. 2A and 2B is an enlarged view showing the accumulation of filtering particles near the outlet of the water filtration device of FIG. 1.

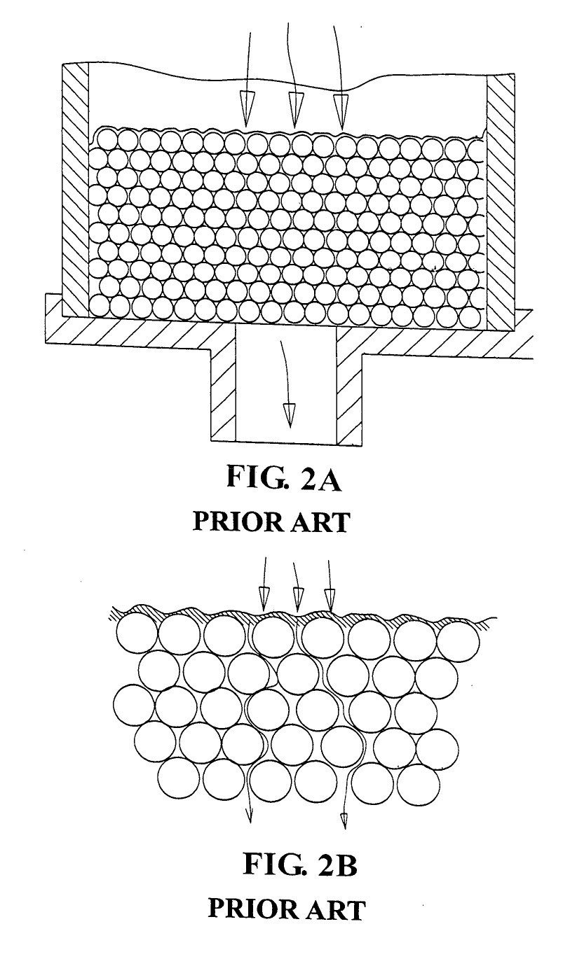

FIG. 3 is a perspective blown-up view showing the various components of the water filtration device according to an embodiment of the present invention.

FIG. 4 is a perspective view showing the outlook of the water filtration device of FIG. 3 after it is assembled.

FIG. 5 is a schematic section view showing the interior of the water filtration device of FIG. 3.

FIG. 6 is a schematic section view showing the scenario of water flow inside the water filtration device of FIG. 3.

FIG. 7 is a perspective view showing the use of the water filtration device of FIG. 3 under a water faucet.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

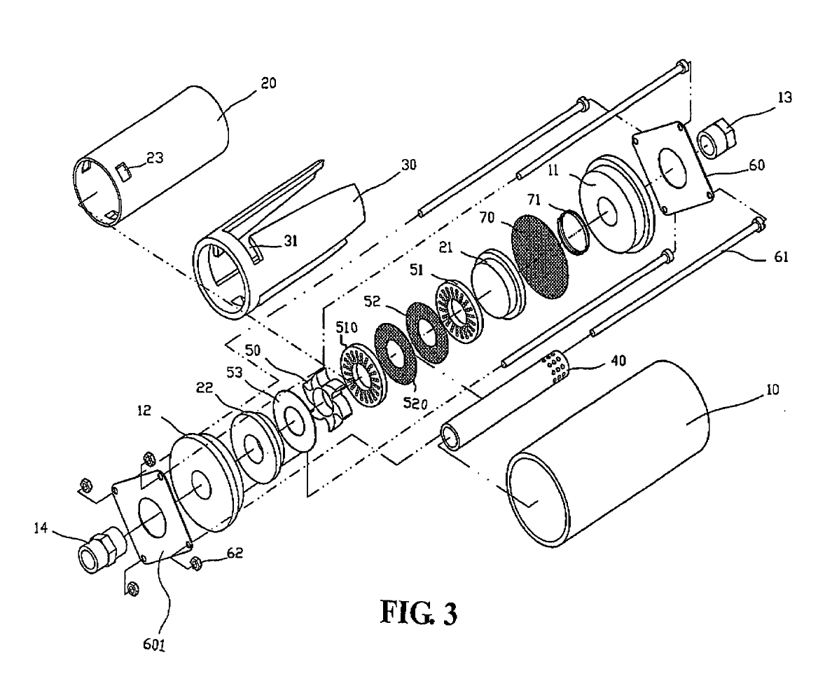

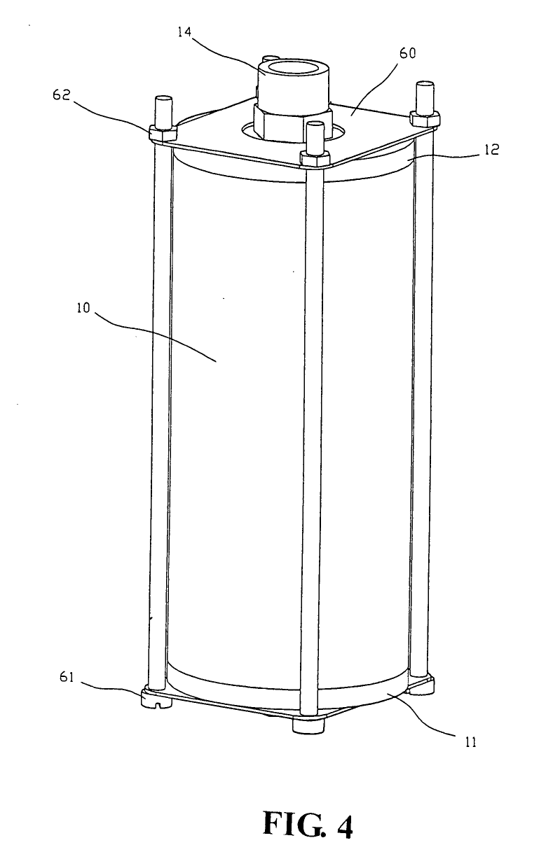

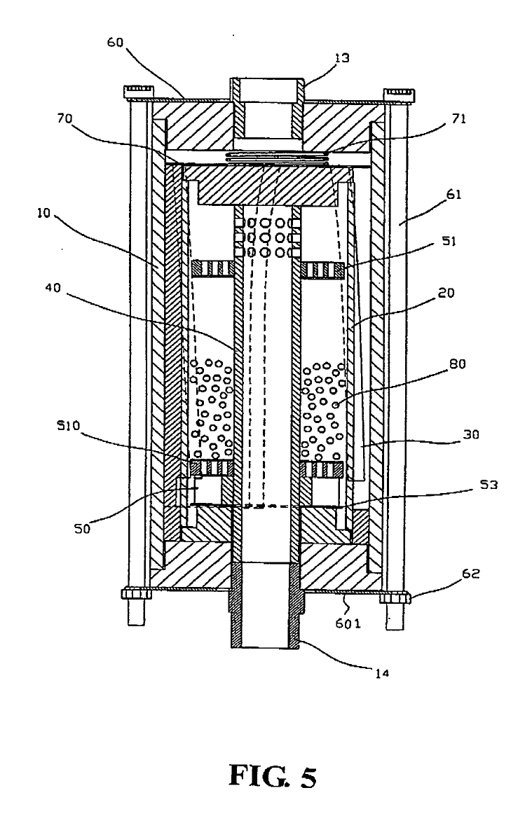

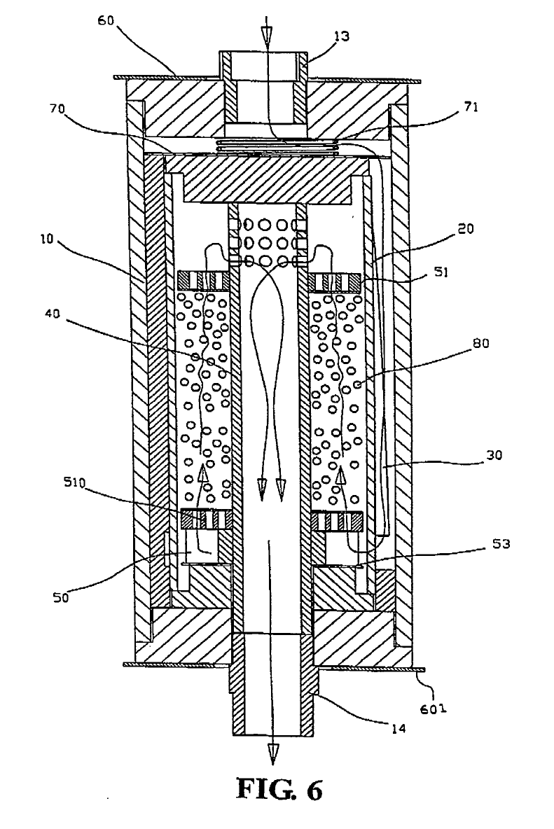

As shown in FIGS. 3 to 6, the water filtration device according to an embodiment of the present invention mainly contains a tubular enclosure 10, an inner tubular member 20, a tubular guiding member 30, and an outlet tube 40.

The outlet tube 40 has a number of through holes (not numbered) along the circumference around its top portion. Beneath the through holes, the outlet tube 40 is threaded through the following components sequentially in this order from top to bottom: an upper filtering plate 51 having an upper filtering screen 52 attached to the bottom, a lower filtering plate 51 having a lower filtering screen 52 attached to the top, a fan 50 having a number of blades, and a pad plate 53. The outlet tube 40 is housed entirely inside the inner tubular member 20 whose top is sealed by a top cover 21 and whose bottom is sealed by a bottom cover 22 having a center through hole allowing the bottom of the outlet tube 40 to pass through. The upper and lower filter plates 51 are appropriately spaced apart and the filtering particles 80 are confined therebetween. The fan 50 and the pad plate 53 are stacked on top of the bottom cover 22. The surface of the pad plate 53 directly contacting the fan 50 is smooth and has a low coefficient of friction. The fan 50 therefore could smoothly spin around the outlet tube 40 6n top of the pad plate 53. At least a through hole 23 is configured at the bottom circumference of the inner tubular member 20, whose location is corresponding to the fan 50.

The inner tubular member 20 is housed inside the tubular guiding member 30. The tubular guiding member 30 has at least a guiding channel 31 configured along the circumference which extends from the top to an appropriate location at the bottom corresponding to the through hole 23 of the inner tubular member 20. The inner tubular member 20 and the tubular guiding member 30 are then together housed inside the tubular enclosure 10. A filtering screen 70 is configured on top of the inner tubular member 20, and a spring 71 is in turn placed on top of the filtering screen 70. The top of the tubular enclosure 10 is then covered by a top cover 11 having a center through hole through which a water inlet 13 is configured. On the other hand, the bottom of the tubular enclosure 10 is covered by a bottom cover 12 having a center through hole allowing the outlet tube 40 to pass through and through which a water outlet 14 is configured. The assembly of the present embodiment is further enhanced by enclosing the tubular enclosure 10 between an upper and a lower fixing plate 60 which are fixedly joined to each other by bolts 61 and nuts 62.

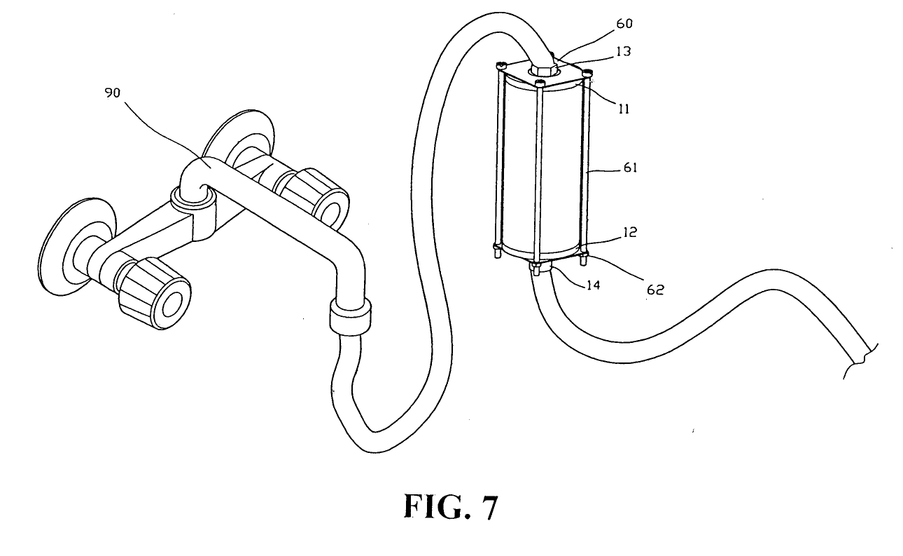

As shown in FIG. 7, when the present embodiment is put to use, a pipe is connected from the water faucet 90 to the water inlet 13 at the top of the water filtration device. As the water flows from the water faucet 90 into the water filtration device, it will first enter the space formed by the filtering screen 70 and the spring 71. The water is then preliminarily filtered as it passes through the filtering screen 70. Subsequently, the water is directed by the guiding channel 31 to flow through the through hole 23 to drive the fan 50 to spin. Propelled by the spinning blades of the fan 50, the water then flows upward and the filtering particles 80 between the filtering plates 51 are stirred and suspended in the water. As such, the filtering particles 80 are able to fully react with the water molecules to remove chlorine and other debris in the water. Via the through holes configured on the top of the outlet tube 40, the treated water then leaves the water filtration device through the outlet tube 40 and the water outlet 14.

The filtering particles 80 are usually made of Calcium Sulfite (CaSO₃) or materials having similar cleansing and purification functions. In some embodiments, if the water already has a certain degree of the cleanness, the filtering screen 70 which provides initial filtering could be omitted.

In summary, the major characteristic of the present invention lies in the use of a fan at the bottom of the water filtration device to propel the water upward to suspend the filtering particles, instead of letting the water to flow downward to confine the filtering particles. As a result, the function of the filtering particles is fully utilized and the water filtration device is operated under a smaller water pressure and therefore has a longer operational life.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-4. (canceled)

5. A water filtration device comprising;
a tubular enclosure having a water inlet at the top and a water outlet at the bottom;
an inner tubular member having at least a through hole on the circumference in the bottom portion of said inner tubular member;
a tubular guiding member having at least a guiding channel configured along the circumference which extends from the top to a location at the bottom corresponding to said through hole of said inner tubular member; and
an outlet tube having a plurality of through holes along the circumference around the top portion, said outlet tube, beneath said through holes, being threaded through in this order from top to bottom; an upper filtering plate having an upper filtering screen attached to the bottom, a lower filtering plate having a lower filtering screen attached to the top, a fan having a plurality of blades, and a pad plate, a plurality of filtering particles between the upper and lower filtering plates and screens;
wherein said outlet tube is sealed inside said inner tubular member and the bottom of said outlet tube is extended out of said inner tubular member;
said inner tubular member and said outlet tube are together housed in said tubular guiding member, which in turn is sealed inside said tubular enclosure;
said water outlet is connected to said outlet tube; water is injected into said water filtration device via said water inlet, directed by said guiding channel to enter said through hole of said inner tubular member; said fan is driven by the water to propel the water upward and to keep said filtering particles suspended amidst the water; and the water then leaves said water filtration device via said through holes on top of said outlet tube and said water outlet.

6. The water filtration device according to claim 5, wherein said filtering particles are made of calcium sulfite (CaSO₃).

7. The water filtration device according to claim 5, wherein the surface of said pad plate directly contacting said fan has a low coefficient of friction.

8. The water filtration device according to claim 5, further comprising a filtering screen located between said tubular enclosure and said inner tubular member to provide initial filtering to the water.
